(19) United States
(12) Patent Application Publication
(10) Pub. No.: US 2013/0147199 A1
(43) Pub. Date: Jun. 13, 2013

(54) Submerged power-generation system

(71) Applicants: Thomas Zambrano, Long Beach, CA (US); Tyler MacCready, Pasadena, CA (US); Taras Kiceniuk, JR., Santa Paula, CA (US); Bart D. Hibbs, Simi Valley, CA (US); Ghyrn E. Loveness, Vashon Island, WA (US)

(72) Inventors: Thomas Zambrano, Long Beach, CA (US); Tyler MacCready, Pasadena, CA (US); Taras Kiceniuk, JR., Santa Paula, CA (US); Bart D. Hibbs, Simi Valley, CA (US); Ghyrn E. Loveness, Vashon Island, WA (US)

(21) Appl. No.: 13/374,078

(22) Filed: Dec. 9, 2011

(51) Int. Cl. F03B 13/00; F03B 17/06

(52) U.S. Cl. 290/54; 416/85

(57) ABSTRACT

A series of helical Savonius turbine generators for use in the ocean, each turbine generator being an independent system, but all sharing a common mooring/bus-bar cable. An anchor connects one generator to the ocean floor, and a buoyancy device system buoys the turbines so that they can generate power from passing currents. The generators are coreless, and generate electrical or hydraulic power. The turbine blades rotate on bearings that are lubricated with ambient water. A control system separately tracks the power generation level of each turbine, and controls the buoyancy of the buoyancy device system.

This application claims the benefit of PCT Application No. PCT/US2010/002938, filed Nov. 8, 2010, which claims the benefit of U.S. provisional Application No. 61/280,672, filed Nov. 6, 2009, both of which are incorporated herein by reference for all purposes.

The present invention relates generally to a submerged power-generation system and, more particularly, to a generator having multiple buoyant power-generation segments connected in series.

### BACKGROUND OF THE INVENTION

The ocean provides one of the most abundant and concentrated forms of energy on the planet. To date, however, ocean power has proven difficult to harness economically, and thus the resource is underutilized. While commercial-level electricity production from ocean currents is a commonly researched goal, small-scale, low power energy harvesting from ocean currents is a separate issue that has not been well addressed. Such energy production may be able to provide considerable benefit for a wide variety of parties having energy needs in locations that do not have access to common energy sources, such as deep-sea locations.

Ocean sensors provide a wealth of information to a number of different sciences, including oceanography, climatology, geology, and marine biology. Tens of thousands of sensors are currently in use to record data on topics such as seismic activity, acoustics, salinity, temperature, and water quality. University researchers, government agencies, non-profit organizations, and others rely heavily on data derived from ocean sensors to further their research, develop policies, and support scientific endeavors. In addition, the U.S. military relies on sensors for weapons programs, surveillance, data collection, and shore protection. Also, commercial enterprises, particularly those involved in energy exploration and production, require the use of ocean-based sensors to collect data on seismic activity and the location and size of offshore oil and gas deposits.

The current method of powering ocean sensors is through single-charge batteries, which have several inherent limitations. Most importantly, batteries have a limited lifespan and need to be replaced, some as often as every 30-40 days. Depending on the accessibility (e.g., the depth) of the sensors, the cost of servicing or replacing such batteries can be exceptionally high in relation to the typical costs of energy. In addition, batteries have environmental costs. As a non-renewable resource, they contribute to environmental degradation through both their production and their repeated replacement.

While it would be advantageous to generate power on the ocean bottom, active mechanical devices have a difficult time functioning at the bottom of the ocean due to a changing and complex ocean-bottom environment, e.g., due to sediment transport. A variety of sedimentary features have been observed in deep-sea sediments, including ripples, mud waves, channels, furrows, and even dunes. Ripples can be formed by contour currents, which typically flow along bathymetric contours along western sides of basins. In passages, the bottom may be scoured of sediment, which lies in drifts on the downstream side. Erosion can cause unconformities or hiatuses in sediment accumulation, particularly in areas where flow is likely to intensify. Furthermore, the sediment water interface on the deep sea floor is not always an abrupt surface. More commonly, the bottom grades from the overlying water column, through a cloud of sediment particles known as the nepheloid layer, to consolidated sediment. A nepheloid layer is quite mobile and can be transported over large distances by bottom currents.

Accordingly, there has existed a need for an underwater power-generation system configured to operate sensors and other devices, and/or to charge underwater batteries so as to extend the life of those batteries. Preferred embodiments of the present invention satisfy these and other needs, and provide further related advantages.

### SUMMARY OF THE INVENTION

In various embodiments, the present invention solves some or all of the needs mentioned above.

The invention is typically embodied in an elongated, ribbon-like string of Savonius current flow turbine generators, each turbine generator being an independent system, but all sharing a common mooring/bus-bar cable that has the dual function of being the mooring line for the system as well as the bus-bar for the power generated by each Savonius turbine.

Advantageously, various embodiments can extend the life of undersea ocean sensors that would typically rely on conventional single charge batteries, and to do so using a technology that relies on a clean, on-site, renewable resource. Moreover, the system can either directly power ocean sensors or recharge their battery systems.

Typically, the system will be relatively lightweight, long lasting, resilient to harsh ocean conditions, capable of satisfying power requirements for sensors or maintaining the charge of their existing underwater energy storage systems, and capable of being rapidly installed by a few people, using conventional shipboard equipment. Using this system, sensors could potentially collect data for longer periods of time, reach deeper waters, collect larger data samples, and be deployed in greater numbers. This can also enhance current and future underwater operations by reducing the number of trips required to deploy replacement batteries and sensors, cutting O&M costs, transportation and personnel costs, and fossil-fuel use. Moreover, the system is anticipated to have minimal impact on marine life and no interference with ship navigation.

The turbine of the present invention is durable enough to withstand extreme currents, and is capable of operating efficiently in a variety of current speeds. Moreover, it is tolerant of partial operational losses due to shifting ocean sediments.

Other features and advantages of the invention will become apparent from the following detailed description of the preferred embodiments, taken with the accompanying drawings, which illustrate, by way of example, the principles of the invention. The detailed description of particular preferred embodiments, as set out below to enable one to build and use an embodiment of the invention, are not intended to limit the enumerated claims, but rather, they are intended to serve as particular examples of the claimed invention.

### BRIEF DESCRIPTION OF THE DRAWINGS

FIG. 1 is an elevational view of a submerged power-generation system comprised of a single power-generation strand, including a plurality of power-generation modules, embodying the present invention.

FIG. 2 is an elevation view of one of the power-generation modules depicted in FIG. 1.

FIG. 3 is the power-generation system of FIG. 1, folded into a configuration for transport and deployment.

FIG. 4A is another view of the power-generation module depicted in FIG. 2.

FIG. 4B is a cross-sectional view of the power-generation module depicted in FIG. 4A, taken along line A-A of FIG. 4A.

FIG. 5A is a cross-sectional, elevation view of a distal end of the power-generation module depicted in FIG. 2.

FIG. 5B is a cross-sectional view of the distal end of the power-generation module depicted in FIG. 5A, taken along line B-B of FIG. 5A.

FIG. 6 is an elevation view of two adjoining (but disassembled) power-generation modules of the power-generation modules depicted in FIG. 1.

FIG. 7 is an elevation view of the submerged power-generation system depicted in FIG. 1, configured to extend up to the surface.

FIG. 8 is a perspective view of a composite power-generation system including a plurality of the power-generation systems depicted in FIG. 1.

FIG. 9 is a perspective view of a second embodiment of the present invention.

FIG. 10 is an elevation view comparing the composite power-generation system of FIG. 8 with a third embodiment of the present invention.

FIG. 11 is an elevation view of a fourth embodiment of the invention.

FIG. 12 is an elevation view of the submerged power-generation system depicted in FIG. 7, with two bottom modules buried by a sediment flow.

### DETAILED DESCRIPTION OF THE PREFERRED EMBODIMENTS

The invention summarized above and defined by the enumerated claims may be better understood by referring to the following detailed description, which should be read with the accompanying drawings. This detailed description of particular preferred embodiments of the invention, set out below to enable one to build and use particular implementations of the invention, is not intended to limit the enumerated claims, but rather, it is intended to provide particular examples of them.

Typical embodiments of the present invention reside in a power-generation system that is configured to operate submerged in a water body (i.e., a body of water) having a bottom (e.g., a seabed), and being characterized by one or more currents of moving water within the water body.

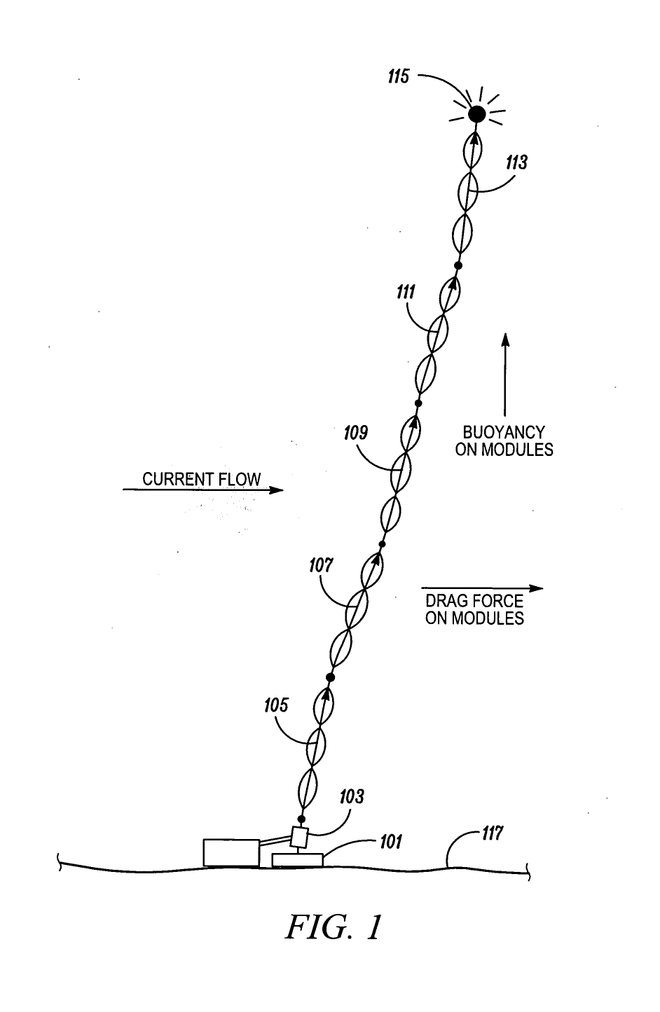

With reference to FIGS. 1 & 2, the power-generation system of the present invention is depicted in FIG. 1 in a deployed configuration, submerged within a body of water. The power-generation system serially includes a mooring anchor 101, a lower, electrical power take-off unit 103, a first power-generation module 105, a second power-generation module 107, a third power-generation module 109, a fourth power-generation module 111, a fifth power-generation module 113, and an upper, electrical power take-off unit 115. The serial connection of one set of these units forms a single power-generation strand, which may serve as a complete power-generation system, or may be connected (in parallel and/or in series) with other power-generation strands to form a composite power-generation system.

Strand of Power-Generation Modules

Each power-generation module forms a proximal end 121 and a distal and 123. The power-generation modules are sequentially connected in series such that the distal end of each power-generation module is connected to the proximal end of the subsequent power-generation module (e.g., the distal end of the first power-generation module 105 is connected to the proximal end of the second power-generation module 107, and the distal end of the second power-generation module is connected to the proximal end of the third power-generation module 109). The proximal end of the first power-generation module is connected to the mooring anchor 101, which fixes the power-generation system at a proximal end to a water-body bottom such as a sea floor 117.

Preferably the power-generation module interconnections are configured and/or coded to avoid accidental connection in an undesirable configuration (e.g., a distal end to distal end). Moreover, the connections are preferably waterproof, have good tensile and torsional strength, and could include a locking mechanism to prevent them from coming apart when the system is in use.

The lower and upper power take-off units (103, 115) are respectively connected to the proximal end of the first power-generation module 105, and the distal end of the fifth power-generation module 113. In various embodiments, the power-generation system may be configured with only a lower power take-off unit, only an upper power take-off unit, or both the lower and upper power take-off units. Furthermore, one or more of the intermediate power-generation modules may also be, or may alternatively be, configured with power take-off units. Because the power-generation strand may extend significantly higher (i.e., less deep) than the loads (e.g., sensors) it supports, it may be desirable for the upper power take-off unit to be configured with communications equipment configured to communicate data from the loads to communication devices on the surface. To this end, the power generation strand would also be provided with a communication system configured to pass information from the loads to the communications equipment.

Each power-generation module (105, 107, 109, 111 and 113) includes a waterproof female connector 131 at its proximal end 121, a rigid, non-rotating central shaft 133, and a waterproof male connector 135 at its distal and 123. The waterproof female connector 131 connects to a proximal end of the central shaft 133 via a torsion-resistant proximal flexible section 137. Likewise, the waterproof male connector 135 connects to a distal end of the central shaft via a torsion-resistant distal flexible section 139.

The central shaft 133 defines a longitudinal axis of the power-generation module, extending substantially from its proximal end to its distal end. For the purposes of this application, this longitudinal axis will be considered the longitudinal axis of the power-generation module. Each flexible section (137, 139) is torsion-resistant, and thus torsional loads around the longitudinal axis can be carried from the proximal end 121 to the distal end 123 of the power-generation module. Nevertheless, the flexible sections (137, 139) are configured such that each end of the power-generation module can bend/rotate laterally (i.e., around any lateral axis, being an axis normal to the longitudinal axis) with respect to the central shaft 133. Typically each flexible section can bend/rotate laterally by at least 90 degrees. While the flexible sections are described as bending, it should be noted that flexible sections in the form of a mechanical hinge-type apparatus, such as a universal joint, would be within the scope of the invention.

With each of the power-generation modules connected serially into a strand, as depicted in FIG. 1, the result is a very flexible chain of power-generation modules, wherein each power-generation module is rigid through most of its longitudinal extent, but is flexible at its ends. With one or more buoyancy devices used to buoy the strand, the resulting strand will rise upward, and yet will bend and flow with the varying currents, not unlike a blade of eelgrass. Advantageously, under all but the most extreme currents, the system will buoyantly extend generally upward so that the upper power-generation modules can function even if the bottom ones are covered with sediment due to changing bottom conditions.

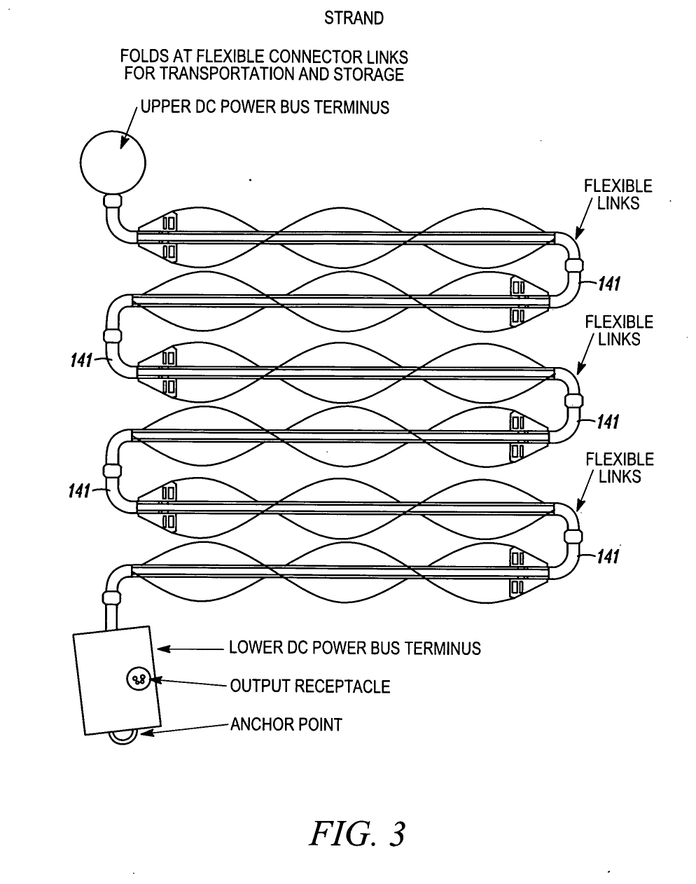

With reference to FIG. 3, the attached proximal flexible section 137 and distal flexible section 139 between each serially connected pair of power-generation modules forms a connection 141 that includes the two torsion-resistant flexible sections (i.e., one at the connected end of each power-generation module). Because of the combined flexibility of the flexible sections, each such connection can bend/rotate laterally by at least 180 degrees. Thus, a power-generation system strand of great length can be folded into a relatively compact configuration suitable for being transported to remote locations in which the power-generation system is to be deployed.

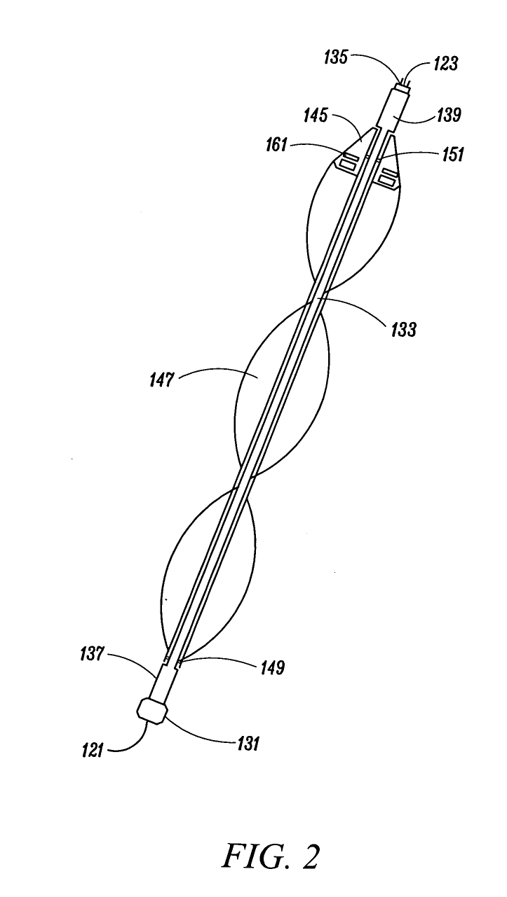

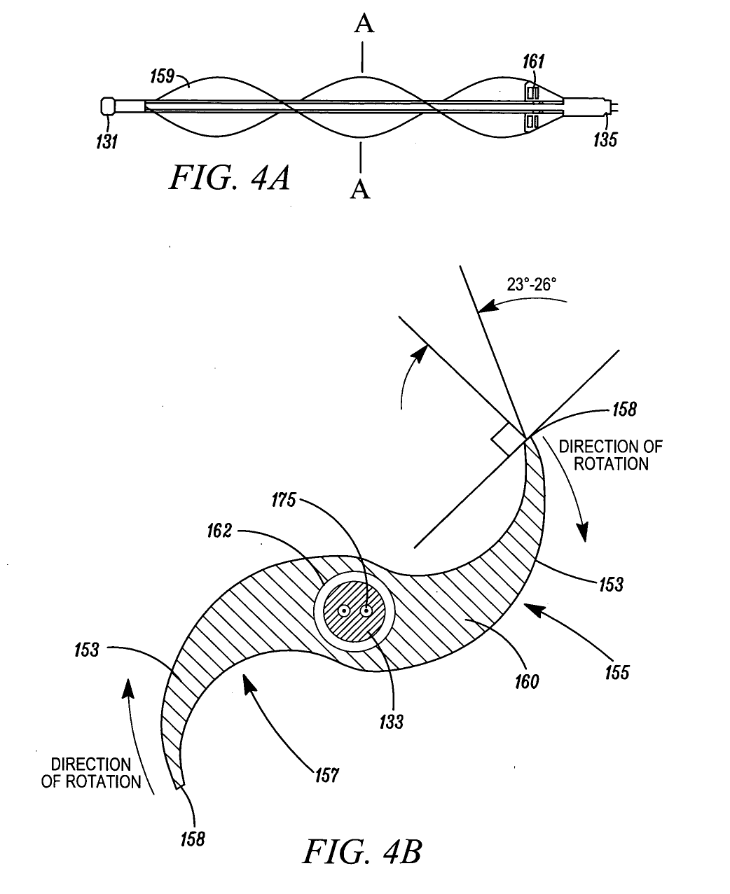

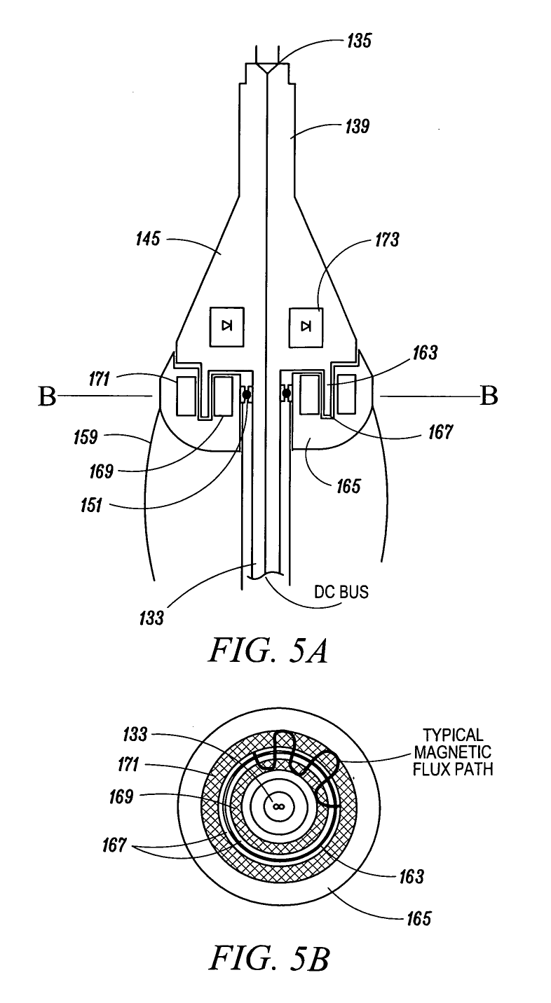

With reference to FIGS. 1, 2, 4A, 4B, 5A and 5B, each power-generation module (105, 107, 109, 111 and 113) includes a non-rotating element 145 rigidly affixed to the distal end of the central shaft 133, and a rotating element (a rotor 147) extending from substantially the proximal end of the central shaft to the non-rotating element 145. The rotor 147 is configured to be driven in rotation around the longitudinal axis by passing water currents, and particularly by water currents passing laterally by the rotor. The rotor is configured with a first water-lubricated bearing 149 at its proximal end (i.e., the end of the rotor proximate the proximal end of the central shaft), and with a second water-lubricated bearing 151 at its distal end (i.e., the end of the rotor proximate the non-rotating element 145) to avoid the need for seals and oily lubricants. These bearings are made using non-corroding materials. Other bearing configurations and compositions are within the scope of the invention.

The rotor is configured with a turbine blade 159 configured to be a Savonius turbine blade, and more particularly, as a helical Savonius turbine blade. A Savonius turbine blade is traditionally understood as a cross-axis turbine for wind, or in a few examples, for water. Commonly, a Savonius turbine blade will have two S-shaped blades in a two-stage configuration that operate primarily using drag. Advantageously, a Savonius turbine blade is omni-directional, and will work in meandering winds (or currents). Moreover, because of the simplicity of the Savonius turbine design, they are extremely reliable and versatile, and may be particularly well-suited for this type of water power generation.

More particularly, at any given cross-sectional location along the turbine blade, the blade includes two flanges 153, each flange having a convex side 155 and a concave side 157. A passing current causes greater drag on the concave side than on the convex side, thus driving the rotor in rotation, with each flange moving toward its convex side (i.e., the concave surface is the trailing backside). Each flange has a tip 158 at which the surfaces of the concave side and convex side meet. For this embodiment, the tip points in a direction that is approximately in the range of 23 to 26 degrees outward of a tangential line drawn at the tip. The turbine blade 159 is substantially thicker in a central portion 160 between the two tips than at the tips. In this thicker portion, the blade forms a hollow bore 162 through which the non-rotating central shaft 133 extends. Alternatively, the blade could be uniformly thin, and/or configured so that the curvature is principally at the outer edge of the rotor. Other types of turbine blades are within the broadest scope of the invention.

The non-rotating element 145 is provided with a buoyancy device. While the buoyancy device could be a simple air-filled enclosure, it will more typically be a crush proof buoyancy device, such as a low-density solid or an enclosure filled with a low-density liquid. The present embodiment is provided with a non-rotating element comprised of a low-density solid structure configured to support portions of a generator, as described below. While the present embodiment uses a buoyancy device located only in the non-rotating element, other options are within the scope of the invention. For example, the central shaft could be buoyant, or even the turbine blades could be buoyant (though that would increase the axial loads on the rotor bearings).

The buoyancy devices of the various power-generation modules distribute the buoyancy of the strand over the length of the strand. This distribution greatly adds to the compliancy of the strand to the action of the currents, and thereby manages loads longitudinally along the strand. Nevertheless, while it is envisioned that many embodiments will use a distributed set of buoyancy devices, it is within the broadest scope of the invention to use only a few, or even only one buoyancy device.

The non-rotating element 145 and the rotor 147 each carry portions of an electrical generator 161 characterized by a non-cogging, coreless design, which will have a low starting torque with no magnetic cogging. More particularly, the non-rotating element 145 is provided with a hollow cylindrical shell protrusion 163 that is concentric with the central shaft and longitudinal axis, and that encapsulates a series of output coils for the generator. The non-rotating element 145 further includes any electronic components, such as a rectifier circuit 173, necessary to condition the generated electrical power for transmission.

The distal end of the rotor 147 is provided with a disk-shaped magnet encapsulation cap 165 having a generally circular longitudinal cross-section. This magnet encapsulation cap is configured with a hollow cylindrical bore 167 configured to conformingly receive the hollow cylindrical shell protrusion 163, while still maintaining a small clearance between the bore and the protrusion. The device is configured to allow water to circulate within this gap. Within the magnet encapsulation cap 165 there is an inner magnet ring 169 and an outer magnet ring 171 that are each concentric with the central shaft and longitudinal axis.

The magnetic rings are configured to provide a serpentine line of magnetic flux, or alternatively a series of loops of flux. This configuration may be constructed of multiple parts, including both magnets and soft iron. The inner and outer magnet rings are positioned such that, with the hollow cylindrical protrusion 163 received in the hollow cylindrical bore 167 the inner and outer magnet rings are concentrically directly positioned radially inward and outward, respectively, of the output coils encapsulated within the hollow cylindrical protrusion.

When driven by currents, the turbine blade drives the magnet rings in rotation with respect to the coils. The coils experience a moving magnetic field that changes in polarity many times per revolution of the turbine blade, generating an AC current within the coils. The size of the coils spans approximately one half of a flux reversal interval. The AC current is fed into the rectifier circuit 173, as mentioned above. While the described generator of this embodiment is a direct-drive, flooded (not sealed) configuration, geared embodiments and sealed generators not permitting the entrance of seawater are also contemplated within the scope of the invention.

Reducing the size of the water gaps and of the encasing material between the magnets and the coils may decrease the necessary size of the magnets. Additionally, as the turbines will be located on the ocean floor where currents transport sediment and organic matter, the blades will have high exposure to biofouling that will degrade the turbine's performance over time. Minimizing the size of the water gaps might limit also biofouling.

Each power-generation module is configured to form an electrical bus 175 that extends from the module's proximal end to its distal end. More particularly, the bus extends serially from the waterproof female connector 131, through the proximal flexible section 137, longitudinally along the central shaft 133, through the distal flexible section 139, to the waterproof male connector 135. The waterproof male and female connectors are configured to form an electrical connection such that the electrical bus of each power-generation module interconnects with the electrical bus of each adjoining power-generation module, thereby forming a uniform bus configured to deliver the power from all of the power-generation modules to any power takeoff and off unit that is part of the power-generation system. The power bus may be configured as a DC bus or an AC bus. Preferably the connections are configured and/or coded to avoid accidental connection in an undesirable configuration (e.g., reversing the desired polarity of the connection). Thus, the power-generation system of the present invention collects locally available energy from ocean currents and puts it on a power bus.

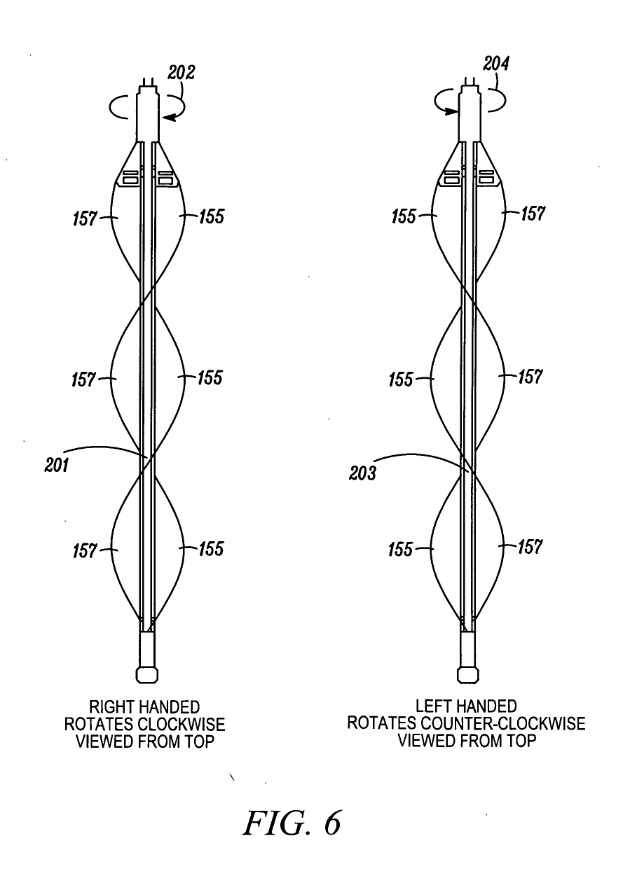

With reference to FIG. 6, it is anticipated that in some embodiments each power-generation module, while generating power, will also experience a lateral side load normal to the direction of the current. With a sequential series of like-spinning power-generation modules in a single strand, the effects of these side loads may be additive, causing an overall side load on the strand that could be equal to or greater than the drag that the strand experiences in the current. This in turn increases the anchoring loads experienced by the mooring 101.

One way to limit this effect is to have the strand composed of alternately counter-rotating power-generation modules. More particularly, a first power-generation module 201 in a strand might be configured such that, in a current, it rotates in a clockwise direction 202 when viewed from the distal end of that power-generation module. A second power-generation module 203 in the strand is then configured such that, in a current, it rotates in a counterclockwise direction 204 when viewed from the distal end of that power-generation module.

With the proximal end of the second power-generation module attached to the distal end of the first power-generation module, and with an even, smooth current, the lateral forces applied to the two power-generation modules will be equal, and in opposite directions. As a result, with a long strand of power-generation modules, each module being counter-rotating to the module on either side of it, the overall force applied to the strand will be comparatively close to zero, and the only effect on the strand might be a comparatively slight variation in its overall shape (i.e., in the bending that occurs between the each power-generation module).

It should be noted that the rotor will drive the non-rotating element 145 in rotation via the generator. Another advantage of using counter-rotating adjacent modules is that the rotational force of each module will be canceled out by the rotational force of its counter-rotating neighbors. Without this cancelation, the full torsional force generated by the entire strand will need to be reacted by the anchor mooring.

Alternatively, if the power-generation modules are configured with like spin directions and the strand is in an unsteady current environment, the strand may experience extensive lateral motion. That motion may in turn lead to additional power generation, albeit at the cost of an increased risk of unseating the mooring and/or having the strand get tangled with itself or neighboring strands.

Regardless of the spin direction of the turbine blades, the helical shape of the blade is configured such that the concave face faces somewhat downward. As a result, when driven by the current, the blade will provide a longitudinal force toward the generator, which for the present embodiment will be in a generally upward direction. Thus when driven, the blade will cause some additional buoyant force.

It may be noted that the power-generation strand is a distributed generation system in which the power-generation modules are independently operable. Thus, while one or more of the power-generation modules may become disabled, such as by biofouling or being buried by sediment flows, the remaining elements may continue to be operable. For example, FIG. 12 depicts the present embodiment with the anchor, the bottom power take-off, the first power-generation module and the second power-generation module buried by a sediment flow. The top three modules are still functional, along with the bottom power take-off.

Accommodations in design can be made for easy placement of a power-generation strand. For example, a single-strand power-generation system can be configured to be assembled or unpacked above the water surface, and then either lowered or allowed to drop to the bottom.

The power-generation modules may be configured to be detachable in the field, either underwater or on the surface. This rapid configurability allows both for changes in the strand configuration, and for the replacement and service of modules that are not correctly functioning.

Compared to the costs of single-charge power system (i.e., a battery), power-generation strands provide an inexpensive and long life alternative. Because of their comparatively low costs, the strands might be considered to be disposable. If they are to be serviced, the height of the strands can simplify their location and recovery. Moreover, the top of the strand may be configured with additional location devices, such as a sonar emitter.

Strand Configuration

A power-generation strand can be customized for a wide variety anticipated environments and loads. This variety may include environments having only low-speed currents, environments having a wide range of currents, environments having current speeds that very significantly by depth, and environments that are subject to heavy sediment movement. To customize a strand based on anticipated conditions, numerous factors may be varied. These factors include screw pitch, power-generation module length, strand length, and the buoyancy levels of each separate module. Within the length of a strand many of these features can be varied to fit anticipated conditions (such as current profiles at different depths).

Moreover, for a strand that would have to extend through depths that are anticipated to be relatively unusable for power generation, comparatively inexpensive dummy modules may be used. These dummy modules would generally still include a rigid central shaft having proximal and distal flexible sections and waterproof connectors, along with a buoyancy element and a power bus that runs the length of the dummy module. The dummy modules would, nevertheless, lack a rotor and its related bearings. Optionally, the dummy module could be a typical power-generation module with its rotor removed (and a weight added to maintain the proper buoyancy), or it could be a separately manufactured module.

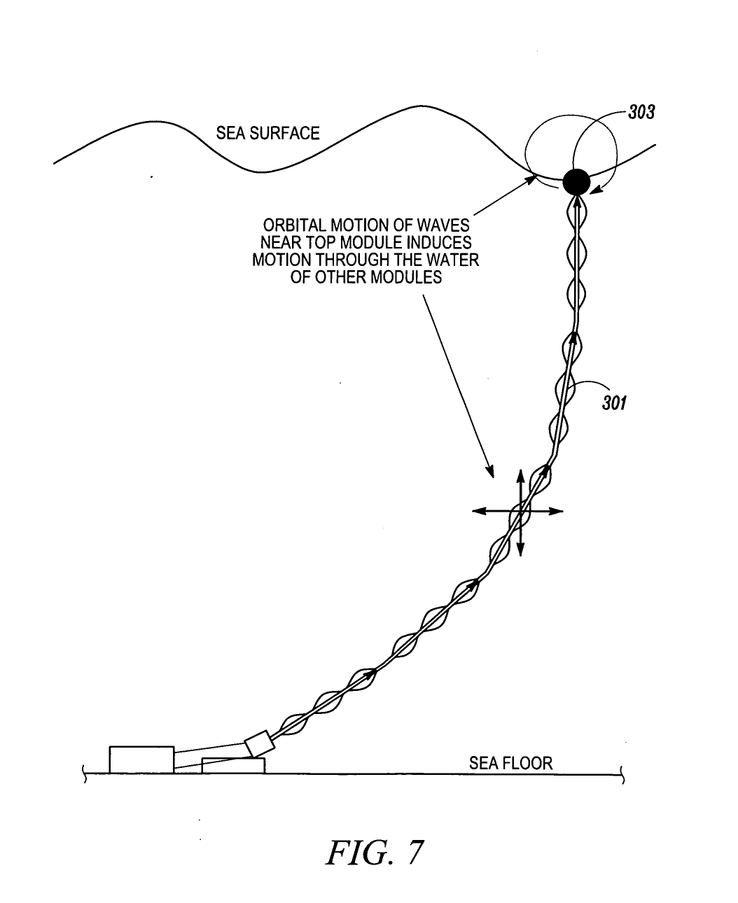

Each strand may further be configured to extend to the surface, or it may be configured to operate deep underwater. With reference to FIG. 7, the use of a strand 301 that interacts with surface waves may generate additional power, in that it may generate additional strand motion by pumping the strand of power-generation modules up and down. More particularly, with the strand being in a curved configuration, such as may be experienced due to a current, at least some of the power-generation modules will experience lateral motion due to the pumping motion. The pumping motion can be accentuated by using a very buoyant buoyancy unit 303 on the top power-generation module, such that the strand is vigorously pulled upward by each passing wave.

Alternatively, a deeper strand can avoid adverse interaction with boats, and very deep water strands might even avoid problems with fishing nets. Moreover, non-surface strands may be subject to less structural degradation due to extreme flexing of the flexible sections, and may be relatively stealthy.

For intermittent loads (e.g., intermittently operated sensors and/or communication devices), the strand may be configured with a power management system. The power management system that includes a rechargeable battery that runs the load during peak power usage times, and that recharges during low power usage times.

Multi Strand Systems

While a single power-generation strand may be configured to be a complete power-generation system, a plurality of strands may be interconnected to provide greater power generation, further redundancy and more widely distributed power generation. Power generation systems of the present invention are very scalable, as increased power generation is derived not by increasing the size of the generators, but rather by adding additional generators to the system (either by using longer strands or more strands).

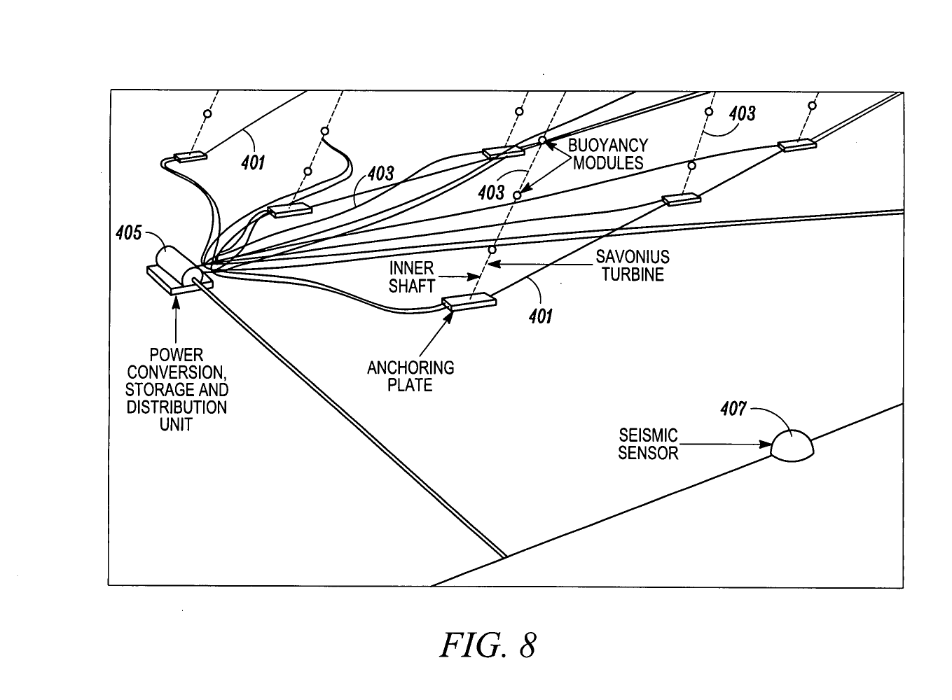

With reference to FIG. 8, power systems under the present invention may be complex arrays of strands. The system may include a plurality of serially connected arrays 401, each array including a plurality of power-generation strands 403, and each array being interconnected to a power conversion, storage and distribution unit 405 (a power management system). This power management system may then interconnect to a series of one or more sensors 407.

As described above with respect to an individual power-generation strand, even a relatively low-power power-generation system comprising a plurality of power-generation strands may be made to support one or more loads (e.g., sensors) that only intermittently need a higher power level to take sensor readings and/or to communicate the results to the surface.

Depending on the deployment conditions, arrays of power-generation strands may be preassembled on shipboard and deployed all at once, or may be individually deployed and then interconnected using divers and or submersible devices.

Optional Control System

The power management system 405 for a power-generation system that includes one or more power-generation strands may include a control system configured to analyze and/or control the operation of the power-generation system. To that end, each power-generation strand may include one or more sensors configured to sense the position and/or configuration of the power-generation strand. Such sensors may include bending sensors configured to sense the relative bending between any two flexibly connected units, possibly providing adequate information to calculate the depth and orientation of each power-generation module. Additionally, such sensors may include depth gauges to explicitly measure the depth of one or more power-generation modules, and/or strain gauges to measure the physical load levels between any two power-generation modules and/or between the power generation modules and the mooring.

Optionally, one or more power-generation modules may be configured with buoyancy devices that have an actively controllable (i.e., variable) buoyancy level. The control system may be configured as a real-time active control system that controls the buoyancy of these controllable buoyancy devices during operation of the power-generation system, particularly to either maximize the power generation capability of the system, or to protect the integrity of the system during conditions of extreme current activity.

Moreover, each power-generation module may include one or more sensors measuring a power-generation level of the power-generation module. These sensors may provide the control system with information that identifies power-generation modules that are incapacitated due to sediment flow (see, e.g., FIG. 12) or malfunctioning. The control system may be further configured to communicate this information to the surface such that appropriate remediation action may be planned when the system is approaching a level of inadequate operation, or may be configured to limit operations of the loads to within the available power levels.

Additionally, using information on the power-generation level of each power-generation module, and information on the depth of each power-generation module, the control system can calculate a current profile by depth (i.e. a profile of current speeds at various depths). Because the power-generation strand is self-contained, and may include communication equipment, this control system function provides for the power-generation strand to be both a sensing system and a related power-generation system.

Some Other Variations

While the above discussion explicitly recited in electrical power generation, the power generation may be of other forms. For example, the power generation may also be hydraulic or fluidic in nature. In that case, modified seawater might be used as an effective working fluid. In fluidic systems, the transfer of energy from the rotor module to the distribution system can utilize mechanical deflection and/or pumping of fluid.

Additionally, while the above discussion explicitly recited power-generation modules that are each provided with their own generator, it is within the broadest scope of the invention to have flexibly interconnected rotor modules configured to drive only a limited number, and perhaps only one, generator. For example, in one alternative embodiment, each pair of adjoining power-generation modules could be provided with a single generator located proximate the connection between the two power-generation modules. The two power-generation modules would have counter-rotating rotors, and the generator would effectively be driven at a rate equal to a sum of the two rotation rates of the power-generation modules. Yet another embodiment could be a synthesis of this embodiment and the original embodiment, i.e., an embodiment that has a generator for every power-generation module, but wherein each generator is driven by two adjacent (and counter-rotating) power-generation modules such that the generator is driven at a rate equal to the sum of their rotation rates.

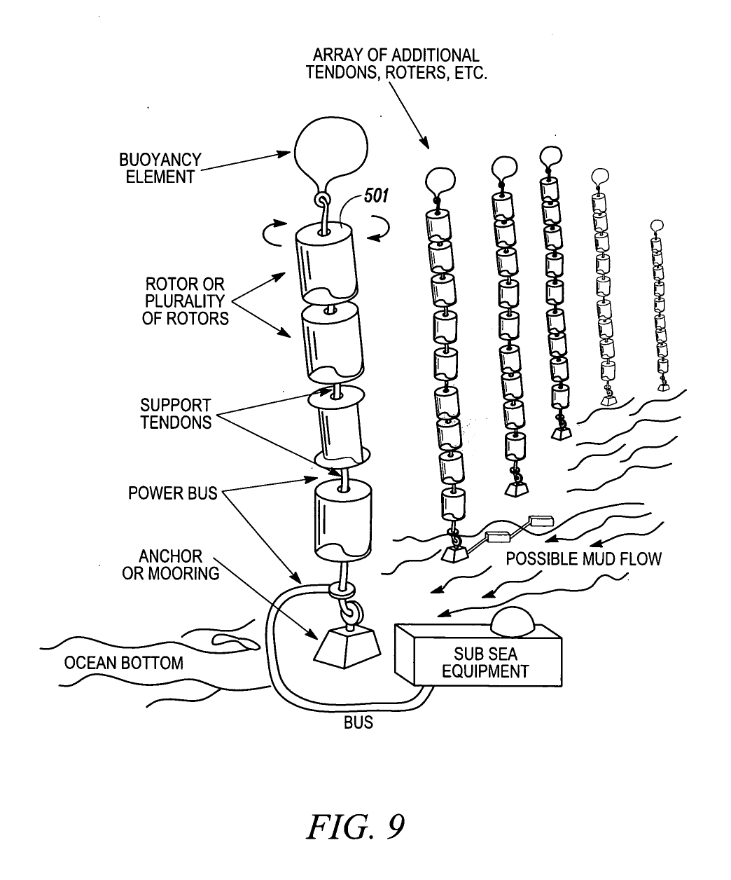

With reference to FIG. 9, another embodiment may use Savonius turbine rotor blades 501 that are not helical in configuration. Optionally these blades may be a rigidly mated set of two or more blades that are offset by even angles (e.g., two blades offset by 90 degrees) so as to provide for efficient startup and smooth operation, as is typically known in the art of atmospheric Savonius turbine blades. While Savonius turbine blades provide a high level of simplicity, other forms of turbine may also be used within the scope of the invention.

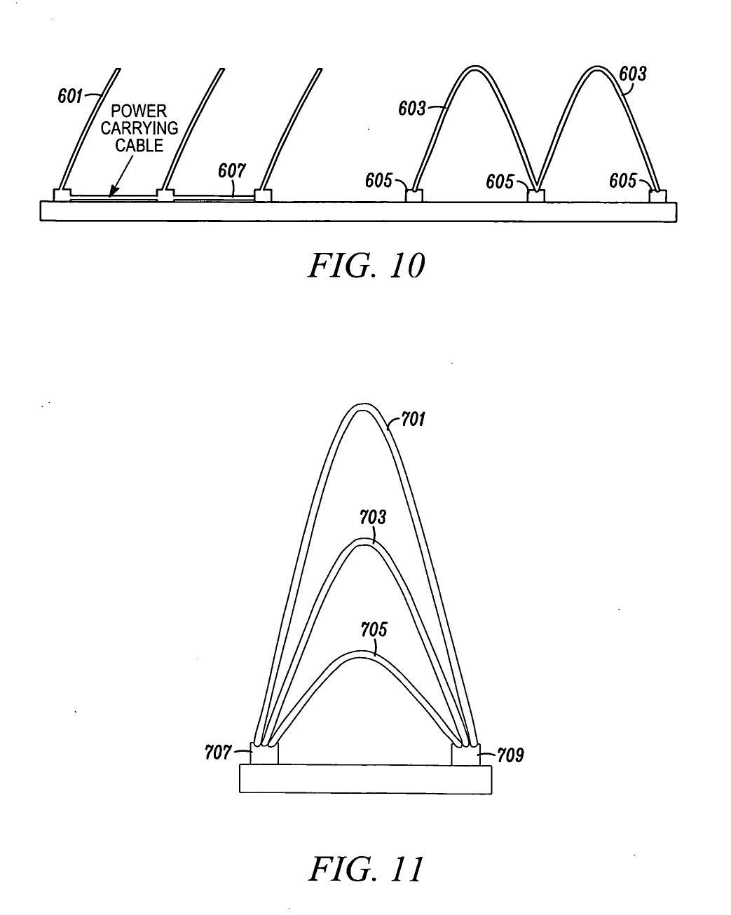

With reference to FIG. 10, in another alternative embodiment, rather than the embodiment 601 depicted in FIG. 8, each power-generation strand 603 may be connected to two moorings 605—one at each end. Moreover, a plurality of power-generation strands may be run in series from mooring to mooring. This configuration provides for power-generation strands to be electrically interconnected without the use of separate cables 607 extending from mooring to mooring. This also might provide for significantly more length of strand to be used within a given area, without substantially increasing their risk of separate strands becoming tangled with one another. It also provides for long strands to be used without extending too far away from the ocean floor.

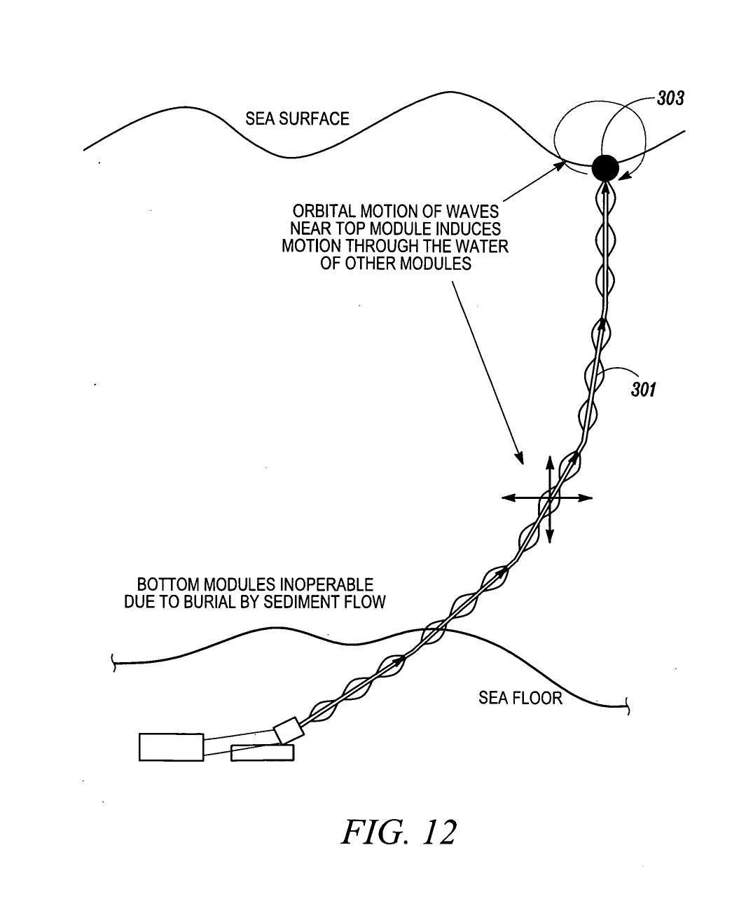

With reference to FIG. 11, in an embodiment similar to that of FIG. 10, another alternative embodiment is provided with a plurality of different-length power-generation strands 701, 703, 705, each of which extends between the same two moorings 707, 709. As with the previous embodiment, a plurality of these could be run in series to increase power generation without the need of interconnecting power cables. This embodiment provides for a very high density power generation system, but might have additional challenges in system design and deployment.

Some variations may include embodiments lacking a central, non-spinning bus bar. For example, the strands could employ a series of alternating helical Savonius turbine blades and generators, where each generator connects only to the turbine blades (via one or more flexible elements). Generated power would then need to be carried down the strand through other means, such as leads passing through the turbine blades and using brushes to connect from module to module. Also, as was discussed above, a variation could have only a single generator that is driven by a series of flexibly connected, buoyant Savonius turbine blades.

It is to be understood that the invention comprises apparatus and methods for designing power systems and for producing power systems, as well as the apparatus and methods of the power systems themselves. Additionally, the various embodiments of the invention can incorporate various combinations of the above-described features of various embodiments. In short, the above disclosed features can be combined in a wide variety of configurations within the anticipated scope of the invention.

While particular forms of the invention have been illustrated and described, it will be apparent that various modifications can be made without departing from the spirit and scope of the invention. Thus, although the invention has been described in detail with reference only to the preferred embodiments, those having ordinary skill in the art will appreciate that various modifications can be made without departing from the scope of the invention. Accordingly, the invention is not intended to be limited by the above discussion, and is defined with reference to the following claims.

What is claimed is:

1. A power-generation system for use in a water body, the water body having water currents and a bottom, comprising:
a first turbine including a first-turbine blade and a first-turbine generator, the first-turbine generator being configured to generate power from relative motion of the first-turbine blade caused by passing water currents, wherein the first turbine is characterized by a longitudinal axis defining a proximal end and a distal end of the first turbine;
a second turbine including a second-turbine blade and a second-turbine generator, the second-turbine generator being configured to generate power from relative motion of the second-turbine blade caused by passing water currents, wherein the second turbine is characterized by a longitudinal axis defining a proximal end and a distal end of the second turbine; and
a second-turbine buoyancy device configured to buoy the second turbine;
wherein the distal end of the first turbine is flexibly connected to the proximal end of the second turbine such that the second turbine can rotate laterally with respect to the first turbine.

2. The power-generation system of claim 1, wherein in response to passing water currents, the first-turbine blade is configured to rotate relative to the first-turbine generator in a first direction, and wherein the second-turbine blade is configured to rotate relative to the second-turbine generator in a direction opposite the first direction.

3. The power-generation system of claim 1, and further comprising an anchor configured for connection to the water-body bottom, wherein the proximal end of the first turbine is flexibly attached to the anchor such that the first turbine can rotate laterally with respect to the anchor.

4. The power-generation system of claim 3, and further comprising:
a third turbine including a third-turbine blade and a third-turbine generator, the third-turbine generator being configured to generate power from relative motion of the third-turbine blade caused by passing water currents, wherein the third turbine is characterized by a longitudinal axis defining a proximal end and a distal end of the third turbine; and
a third-turbine buoyancy device configured to buoy the third turbine;
wherein the distal end of the second turbine is flexibly connected to the proximal end of the third turbine such that the third turbine can rotate laterally with respect to the third turbine.

5. The power-generation system of claim 4, wherein in response to passing water currents, the first-turbine blade is configured to rotate relative to the first-turbine generator in a first direction, wherein the second-turbine blade is configured to rotate relative to the second-turbine generator in a direction opposite the first direction, and wherein the third-turbine blade is configured to rotate relative to the third-turbine generator in the first direction.

6. The power-generation system of claim 5, and further comprising a first-turbine buoyancy device configured to buoy the first turbine.

7. The power-generation system of claim 1, wherein the first- and second-turbine blades are helical blades.

8. The power-generation system of claim 1, wherein the first- and second-turbine blades are Savonius turbine blades.

9. The power-generation system of claim 1, wherein the first- and second-turbine blades are helical Savonius turbine blades.

10. The power-generation system of claim 1, wherein the first- and second-turbine generators are coreless generators.

11. The power-generation system of claim 1, wherein the first- and second-turbine blades rotate on bearings that are lubricated with ambient water.

12. The power-generation system of claim 1, wherein the first- and second-turbine generators generate electrical power.

13. The power-generation system of claim 1, wherein the first- and second-turbine generators generate hydraulic power.

14. The power-generation system of claim 1, and further comprising a control system, wherein the control system is configured to separately track the power generation level of each turbine.

15. The power-generation system of claim 1, and further comprising:
a first-turbine buoyancy device configured to buoy the first turbine; and
a real-time active control system, wherein each buoyancy device has a controllable level of buoyancy, and wherein the control system is configured to separately control the buoyancy level of each buoyancy device during operation of the power-generation system.

16. The power-generation system of claim 1, wherein the screw pitch of each turbine blade is individually selected based on an analysis of anticipated flow conditions.

17. A power-generation system for use in a water body, the water body having water currents and a bottom, comprising:
a first-turbine blade characterized by a longitudinal axis defining a proximal end and a distal end;
a second-turbine blade characterized by a longitudinal axis defining a proximal end and a distal end, wherein the proximal end of the second-turbine blade is flexibly connected to the distal end of the first-turbine blade;
a buoyancy device system configured to buoy the first-turbine blade and second-turbine blade; and
a generator;
wherein the first-turbine blade and second-turbine blade are configured to be driven in rotation around their respective longitudinal axes by the water currents when the blades are buoyed by the buoyancy device within the water body;
wherein the generator is configured to generate power from rotation of the first-turbine blade and rotation of the second turbine blade.

18. The power-generation system of claim 17, wherein the generator is configured to generate power from the relative rotation of the first-turbine blade and second-turbine blade.

19. The power-generation system of claim 17, and further comprising an anchor configured for connection to the water-body bottom, wherein the proximal end of the first turbine is flexibly attached to the anchor such that the first turbine can rotate laterally with respect to the anchor.

20. The power-generation system of claim 17, wherein the first- and second-turbine blades are helical blades.

21. The power-generation system of claim 17, wherein the first- and second-turbine blades are Savonius turbine blades.

22. The power-generation system of claim 17, wherein the first- and second-turbine blades are helical Savonius turbine blades.

23. The power-generation system of claim 17, wherein the generator is a coreless generators.

24. The power-generation system of claim 17, wherein the first- and second-turbine blades rotate on bearings that are lubricated with ambient water.

25. The power-generation system of claim 17, wherein the generator generates electrical power.

26. The power-generation system of claim 17, wherein the generator generates hydraulic power.

27. The power-generation system of claim 17, and further comprising a control system, wherein the control system is configured to separately track the power generation level of each turbine.

28. The power-generation system of claim 17, wherein the buoyancy device system includes:
a first-turbine buoyancy device configured to buoy the first-turbine; and
a second-turbine buoyancy device configured to buoy the second-turbine; and
a real-time, active control system, wherein each buoyancy device has a controllable level of buoyancy, and wherein the control system is configured to separately control the buoyancy level of each buoyancy device during operation of the power-generation system.

29. The power-generation system of claim 17, wherein the screw pitch of each turbine blade is individually selected based on an analysis of anticipated flow conditions.
